(19) United States
(12) Patent Application Publication
(10) Pub. No.: US 2014/0312531 A1
(43) Pub. Date: Oct. 23, 2014

(54) Corrugation device for sheets of paper material

(71) Applicants: Giuseppe BRIVIO, BESANA BRIANZA (Monza Brianza) (IT); Renato ROSSI, BIASSONO (Monza Brianza) (IT)

(72) Inventors: Giuseppe BRIVIO, BESANA BRIANZA (Monza Brianza) (IT); Renato ROSSI, BIASSONO (Monza Brianza) (IT)

(73) Assignee: ITALDRY S.R.L., BRIOSCO (Monza Brianza) (IT)

(21) Appl. No.: 13/866,515

(22) Filed: Apr. 19, 2013

(51) Int. Cl. B31F 1/20

(52) U.S. Cl. CPC B31F 1/20
USPC 264/284; 425/237

(57) ABSTRACT

Provided is a corrugation device for sheets of paper material including two corrugation cylinders having work surfaces configured to substantially engage reciprocally so as to define a deformation zone and impress a deformation force on sheets of paper material and at least one thrust member suitable to define a working configuration in which it exerts on one of the work surfaces an additional pressure able to vary the deformation force and a rest configuration in which it does not exert the additional pressure.

### TECHNICAL BACKGROUND OF THE INVENTION

The present invention relates to a corrugation device for sheets of paper material of the type comprising two corrugation cylinders having work surfaces suitable to substantially reciprocally engage so as to define a deformation zone and to impress a deformation force on the sheets in paper material.

### DESCRIPTION OF THE PRIOR ART

In particular, the invention relates to a device in which a sheet of paper material, presenting itself as initially flat, undergoes a plastic deformation suitable for giving it a corrugated profile so as to be used, for example, to make corrugated board.

Currently, the corrugation devices known in the prior art are composed, mainly, of a calender having two corrugation cylinders shaped in such a way as to plastically deform the sheets and thus give them a corrugated profile.

In particular, said corrugation cylinders have the outer surface suitably corrugated so as to reciprocally engage and thereby define a work zone through which the sheets pass, undergoing the plastic deformation. The force needed to deform the sheets is applied to the corrugation cylinders by means of thrust devices which act on the ends of said cylinders. The distribution of the force needed, to be applied evenly all over the mechanical clearance of the machine, is performed thanks to the camber of one of the two cylinders, the value of which is calculated to offset the elastic deformation of said corrugation cylinders. It follows that the force for deforming the sheets may be a single value, calculated at the design phase and related to the geometry and elasticity of the corrugation cylinders.

The prior art described above has several significant drawbacks.

A first significant drawback is represented by the limited adaptability of the corrugation devices to sheets of varying thicknesses and/or made of different materials.

In fact, in the event of processing a sheet having different chemical-physical characteristics from those hypothesised at the design stage, the corrugation cylinders discharge a force onto the sheets not suitable to plastically deform them.

For example should the sheets have a greater mechanical resistance, the force applied by the cylinders proves insufficient for their plastic deformation and consequently an elastic deformation occurs which is practically immediately reabsorbed, once the force of the cylinders is removed. Conversely, should the sheets have a lower mechanical resistance, the force applied causes the tearing of the sheets determining a reduction in quality of the board produced and, in some cases, a halt to production with relative increase in costs.

Other problems may also be encountered in the case of processing sheets of a different thickness to those designed for; in this case too, the corrugation cylinders are unable to perform optimal deformation of the sheets.

In particular, such problem is due to the fact that, on account of the different thickness, the corrugation cylinders apply a different force to the sheets from that needed and may consequently perform a plastic deformation or tearing of the sheets.

For such reasons, in the case in which a firm wishes to process sheets of paper material having different characteristics, it is forced to purchase a plurality of corrugation cylinders having different dimensions from each other, or must accept the reduction of the mechanical characteristics of the board, sometimes offsetting such with a greater quantity of raw material.

### SUMMARY OF THE INVENTION

In this situation the technical purpose of the present invention is to develop a corrugation device for sheets of paper material able to substantially overcome the inconveniences mentioned above.

Within the sphere of said technical purpose one important aim of the invention is to develop a device which is able to optimally process even sheets having different characteristics from those planned for without replacing rollers, corrugation cylinders or the like.

Another important aim of the invention is therefore to obtain a device able to perform the correct plastic deformation of any type of sheet.

The technical purpose and specified aims are achieved by a corrugation device for sheets of paper material comprising: two corrugation cylinders having work surfaces suitable to substantially engage reciprocally so as to define a deformation zone and impress a deformation force on sheets of paper material, at least one thrust member suitable to define at least one working configuration in which it exerts on one of the work surfaces an additional pressure able to vary the deformation force and a rest configuration in which it does not exert the additional pressure on said work surfaces.

### BRIEF DESCRIPTION OF THE DRAWINGS

The characteristics and advantages of the invention are clearly evident from the following detailed description of a preferred embodiment thereof, with reference to the accompanying drawings, in which:

FIG. 1 shows the corrugation device for sheets of paper material according to the invention in a first working configuration; and

FIG. 2 shows the same corrugation device for sheets of paper material in a different configuration from that shown in FIG. 1.

### DETAILED DESCRIPTION OF THE PREFERRED EMBODIMENTS

With reference to said drawings, reference numeral 1 globally denotes the corrugation device for sheets in paper material 1.

It comprises a frame able to contain within it the various components, a calender 20, including two corrugation cylinders, including of different diameters, suitable to exert a deformation force on the sheet of paper material 10, and at least one thrust member 30 able to vary the deformation force exerted by the corrugation cylinders on the sheet 10.

The calender 20 comprises two cylinders preferably at least partially hollow so as to allow an internal passage of a hot fluid (air and/or steam and/or heat-transmitting oil), with lightening apertures. In detail, it includes a first corrugation cylinder 21 along which the sheet of paper material 10 slides during processing and a second corrugation cylinder 22 suitable to engage with the first corrugation cylinder 21 defining a deformation zone 20a inside which the sheet of paper material 10 passes and is simultaneously subjected to plastic deformation becoming a corrugated sheet.

The first corrugation cylinder 21 and the second corrugation cylinder 22 are laterally connected to the frame so that during the advancement of the sheets 10, they are able to rotate, in relation to the frame, around a first rotation axis 21a and a second rotation axis 22a, substantially parallel to each other.

These axes are sized and/or connected by means of pins, bearings or other elements so as to allow slight flexings thereof if subjected to predetermined mechanical forces.

Moreover, the first 21 and the second corrugation cylinder 22 have suitably corrugated outer lateral surfaces respectively defining the first work surface 21b and the second work surface 22b. In detail, the work surfaces 21b and 22b are corrugated and suitable to reciprocally engage so that between them the aforesaid deformation zone 20a is substantially defined through which the sheet 10 passes and deforms plastically in a counter-shaped manner to the work surfaces 21b and 22b.

In order to perform the correct deformation of the sheet 10, the corrugation device 1 has, in correspondence with at least one of the cylinders 21 and 22, at least one thrust member 30 suitable for varying the deformation force by applying an additional pressure to one of the work surfaces (21b, 22b). Preferably, the corrugation device 1 has at least two thrust members 30 positioned alongside one another and suitable to apply the additional pressure to one of the work surfaces (21b, 22b) and, even more preferably, to the second work surface 22b.

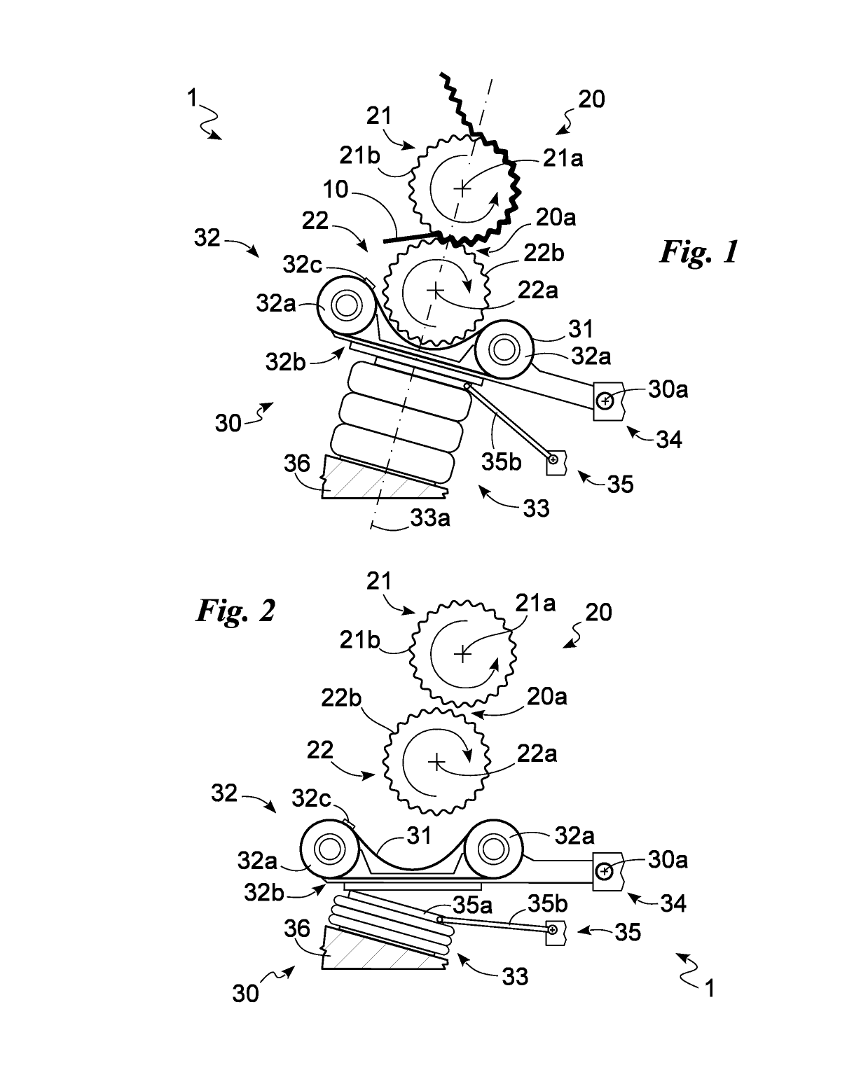

The thrust member 30 is suitable to define a rest position, shown in FIG. 2, wherein the thrust member 30 does not discharge such additional pressure on the work surface 22b and consequently the deformation force has a minimum value, and at least one working configuration, shown in FIG. 1, wherein it applies an additional pressure to the work surface 22b so as to increase the deformation force.

To such purpose, it comprises at least one pressure body 31 suitable to exert the additional pressure on the work surface 22b, a support structure 32, suitable to support the pressure body 31, and drive means 33 suitable to move the support structure 32 and the pressure body 31 so as to allow the thrust member 30 to vary its configuration.

The pressure body 31 is suitable to be pressed against the second work surface 22b so as to discharge the additional pressure onto the second corrugation cylinder 22.

It may therefore be composed of a body counter-shaped to the outer profile of the second corrugation cylinder 22 or alternatively by a belt or similar element suitable to be deformed, preferably elastically, so as to acquire a counter-shape to the aforesaid outer profile.

Preferably, the pressure body 31 is composed of said belt able to discharge the additional pressure on the surface 22b in an optimal manner.

The support structure 32 comprises one or more pairs of pulleys 32a, each of which is able to permit the pressure body 31 to be moved in relation to the support structure 32, and a support 32b able to sustain the pulleys 32a and thereby the pressure body 31 in the correct position.

It may in addition comprise at least one stop element 32c able to keep the pressure body 31 in the correct position.

The thrust member 30, arranged on the side opposite the pressure body 31 in relation to the support structure 32, has the drive means 33 suitable to permit it to vary its configuration.

In particular, the drive means 33 move the support structure 32 in such a way that the pressure body 31 comes into contact with the work surface 22b substantially diametrically opposite to the deformation zone 20a.

It is thus able to exert on the support structure 32 a force having a direction of action 33a substantially perpendicular to the deformation zone 20a, that is substantially perpendicular to the rotation axes 21a and 22a. Preferably, the force has a direction of action 33a substantially lying on a plane defined by the axes 21a and 22a and substantially perpendicular to said rotation axes 21a and 22a.

The drive means 33 therefore comprise a linear actuator suitable to apply the aforementioned force by means of a variation in extension substantially parallel to the direction of action 33a. In particular, the drive means 33 comprise a series of pneumatic or hydraulic actuators suitable to vary their extension following a variation in internal pressure. Preferably, the drive means 33 comprise an inner tube provided with specific attachments for a power supply system which, by varying the internal pressure of the inner tube, causes an expansion thereof having a main direction of extension substantially parallel to the direction of action 33.

To enable the drive means 33 to correctly drive the support structure 32, the thrust member 30 comprises a connection 34 suitable to weakly connect the support structure 32 to the frame so as to guide the movement of the support structure 32 to the second corrugation cylinder 22, an interconnection apparatus 35, suitable to position itself between the drive means 33 and the support 32b so as to permit a correct transfer of force between the aforesaid components, and a base wedge 36 suitable to position the drive means 33 in an inclined position so that, as described above the main direction of extension is substantially parallel to the direction of action 33a.

The connection 34 preferably comprises a pin or other similar connection suitable to define a relative rotation axis 30a of the support structure 32 and therefore of the pressure body 31 in relation to the second corrugation cylinder 22.

Preferably, the relative rotation axis 30a is substantially parallel to the rotation axes 21a and 22 of the corrugation cylinders 21 and 22.

The interconnection apparatus 35 comprises a contact plate 35a placed between the drive means 33 and the support structure 32 and a kinematism suitable to allow the contact plate 35a to follow the drive means 33 during the configuration between the two rest and work configurations.

In particular, the contact plate 35a is firmly connected to the drive means 33 so that when the thrust member 30 passes from the rest to the work configuration, it settles on the support 32b, permitting the correct transfer of forces between the drive means 33 and the support 32b.

To provide the aforesaid movement of the plate 35a, the kinematism comprises a junction element 35b connected to the contact plate and to the frame by means of two pins which allow the junction element 35b to rotate both in relation to the frame and in relation to the contact plate 35a around rotation axes substantially parallel to the relative rotation axis 30a.

The functioning of the corrugation device according to the invention for sheets of paper material, described above in a structural sense, is as follows: initially the device 1 has the thrust member 30 in the rest position, that is with the pressure body 31 suitably separate from the work surface 22b so that the additional pressure is not discharged onto the second corrugation cylinder 22, and thus the deformation force is at its minimum value.

During processing, depending on the characteristics of the sheets of paper material 10 to be processed, the operator adjusts the device 1 so as to achieve the desired deformation force.

In particular, if the sheets of paper material 10 have a minimum thickness, namely practically the same as that estimated during the design stage of the corrugation cylinders, the deformation force required is minimal, and consequently the device 1 is activated leaving the thrust member 30 in the rest position.

Vice versa, if the thickness of the sheets of paper material 10 is greater than the aforesaid minimum thickness and therefore the deformation force required is greater, the operator activates the passage of the thrust member 30 from the rest to the working position so as to apply the additional pressure to the second corrugation cylinder 22 and thus increase the deformation force.

In detail, the drive means 33 expand along the direction of action 33a making the support structure 32 rotate around the relative rotation axis 30a and the pressure bodies 31 settle on the second work surface on the side opposite the deformation zone 20a.

Once the pressure bodies 31 and the work surface 22b are touching, the drive means 33 continue to expand along said direction of action 33a so that the pressure bodies 31 become taut and start to discharge an additional pressure on the second work surface 22b resulting substantially perpendicular to the deformation zone 20a and, preferably lying on the plane defined by the two rotation axes 21a and 22a.

On account of the additional pressure, the rotation axis 22 and/or the second corrugation cylinder 22 begin to deform and/or flex elastically determining, in correspondence with the deformation zone 20a, a reduction of the distance between the work surfaces 21b and 22b and thus, an increase of the deformation force undergone by the sheet of paper material 10 when it crosses said deformation zone 20a.

A minimum deformation or flexing of the second rotation axis 22a and/or of the second corrugation cylinder 22 is sufficient to achieve a significant variation in pressure on the sheet of paper material 10. The flexing may therefore be a consequence both of the size of the corrugation cylinders and the rotation axes, and of the type of connection thereof.

Once the deformation force has reached the desired value, the operator stops the expansion of the drive means 33 blocking the thrust member 30 in the position reached, and then commencing processing of the sheet 10.

The invention, as may be seen from the functioning described above, permits a new corrugation process of sheets in paper material.

Such corrugation process preferably comprises a calibration step of the deformation force during the processing of the sheet of paper material 10.

In particular, in the calibration step, an additional pressure is applied to the second corrugation cylinder 22 by means of the thrust member 30 which, proving substantially parallel to the direction of action 33a, draws the second work surface 22b toward the first work surface 21b and thus varies the deformation force, as described above.

The invention achieves some important advantages.

A first important advantage lies in the extreme reliability of the corrugation device 1 of sheets of paper material 10 having different thicknesses and/or made from different materials from those for which the corrugation cylinders 21 and 22 were designed.

Such advantage is achieved thanks to the innovative thrust member 30 which by exerting an additional pressure on the contact surface 22b, determines an increase of the deformation force.

Another important advantage lies in the fact that the corrugation device 1 can adapt to sheets of paper material 10 of varying thicknesses in a fast and practical manner, and thus without the need for time-consuming and expensive calibration operations.

In fact, the device 1, while having corrugation cylinders 21 and 22 designed to process sheets of paper material 10 of a minimal thickness, is also able to process sheets 10 of greater thickness, increasing the deformation force thanks to the thrust members 30.

Another advantage is therefore the fact that, the device 1, being able to adapt to various types of sheet of paper material 10, minimises the number of corrugation cylinders needed.

Another advantage of no less importance is the greater production capacity of the device 1 thanks to a significantly shorter calibration time compared to the devices of the prior art.

All the elements as described and claimed herein may be replaced with equivalent elements and the scope of the invention includes all other details, materials, shapes and dimensions.

1. A corrugation device for sheets of paper material comprising:
two corrugation cylinders having work surfaces configured to substantially reciprocally engage defining a deformation zone and impress a deformation force on said sheets of paper material;
at least one thrust member configured to exert an additional pressure on one of said work surfaces, whereby the additional pressure varies said deformation force, and a rest configuration in which the thrust member does not exert said additional pressure on said work surfaces.

2. The corrugation device of claim 1, wherein said additional pressure is provided substantially perpendicular to said deformation zone.

3. The corrugation device of claim 1, wherein said one thrust member comprises: at least one pressure body which, when said thrust member passes into said working configuration, comes into contact with one of said work surfaces exerting additional pressure on it; and drive means configured to move said pressure body varying the configuration of said thrust member.

4. The corrugation device of claim 3, wherein said drive means are configured to move said pressure body exerting a force having a direction of action substantially perpendicular to said work zone.

5. The corrugation device of claim 3, wherein said corrugation cylinders are engaged to rotation axes and wherein said drive means rotate said pressure body around a relative rotation axis substantially parallel to said rotation axes.

6. The corrugation device of claim 3, wherein said drive means are pneumatic actuators configured to expand along a main direction of extension.

7. The corrugation device of claim 6, wherein said drive means are inner tubes.

8. The corrugation device of claim 3, wherein said main direction of extension is substantially parallel to said direction of action.

9. A method for corrugating sheets of paper material, comprising: processing said paper material comprising engaging corrugation cylinders to rotation axes apply a deformation force on said sheets of paper material; and calibrating comprising applying an additional pressure to at least one of said corrugation cylinders configured to vary said deformation force.

10. The corrugation method of claim 9, wherein, in said calibrating step, said additional pressure elastically deforms at least one of said corrugation cylinders varying said deformation force.
